(19) United States
(12) Patent Application Publication
(10) Pub. No.: US 2008/0230998 A1
(43) Pub. Date: Sep. 25, 2008

(54) Hermetic Sealing System

(75) Inventors: Robert Adler, Gerasdorf (DE); Georg Siebert, Wien (AT)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Munich (DE)

(21) Appl. No.: 11/996,827

(22) PCT Filed: Jul. 4, 2006
(86) PCT No.: PCT/EP2006/006519

§ 371 Date: Jan. 25, 2008

(30) Foreign Application Priority Data
Jul. 26, 2005 (DE) 10 2005 034 908.0

(51) Int. Cl. F16J 15/16; F16J 15/00

(52) U.S. Cl. 277/434; 92/83

(57) ABSTRACT

A sealing system for two components which can be moved in relation to one another, in particular for a piston which can be moved in a cylinder chamber or for a piston rod, is disclosed. The sealing system has two or more moving seals. An ionic liquid is arranged between at least two of the moving seals.

This application claims the priority of International Application No. PCT/EP2006/006519, filed Jul. 4, 2006, and German Patent Document No. 10 2005 034 908.0, filed Jul. 26, 2005, the disclosures of which are expressly incorporated by reference herein.

### BACKGROUND AND SUMMARY OF THE INVENTION

The invention relates to a sealing system for two components that can be moved in relation to one another, in particular for a piston which can be moved in a cylinder chamber or for a piston rod, the sealing system having two or more moving seals.

Moreover the invention relates to a work machine of any type.

Sealing systems of the generic kind are used for example in hydrogen compressors as hermetic seals for the piston rod.

All seals known to those skilled in the art should be understood under the term “moving seal,” such as those that are used in pistons, piston rods, etc. for example.

All previously known seals are subject to more and less great wear. The consequence of this is that the seals have to be replaced at regular intervals. Often replacement of a seal requires time-consuming, complicated and therefore expensive maintenance work. Till now it has only been possible to dispose of used seals, rather than processing them.

### BRIEF DESCRIPTION OF THE DRAWINGS

FIG. 1 illustrates a conventional sealing system.

FIG. 2 illustrates a sealing system in accordance with the principles of the present invention.

### DETAILED DESCRIPTION OF THE DRAWINGS

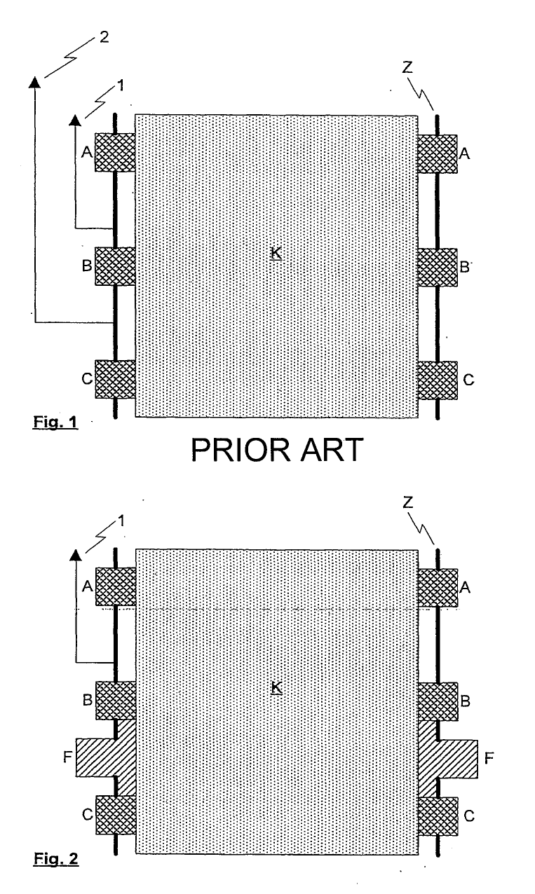

FIG. 1 shows a schematic lateral sectional representation of a piston rod passage Z like those that are required in hydrogen compressors for example. This piston rod passage Z is used to guide a piston rod K. In this case, the compressor's gas chamber is above the piston rod K and the compressor external chamber is below. Furthermore, a prior art sealing system is depicted comprised of three seals A, B and C arranged in the piston rod passage Z, whereby all known seal types may be used in any combination as seals A, B and C.

The first seal A guarantees a seal to the gas chamber, which is located above the piston K. If this seal A becomes leaky and if gaseous medium gets into the chamber between seals A and B, the gaseous medium is removed from this chamber via line 1 and supplied to the suction side of the compressor. If the second seal B also becomes leaky and the gaseous medium enters the intermediate space between the second and third seals B and C, the gaseous medium can be extracted from this intermediate space via line 2 and supplied to a chimney system. This type of chimney system must always be provided if the discharge of gas into the compressor environment should or must be avoided, for example in order to prevent the formation of an explosive gas mixture.

The third seal C is used to prevent the to-be-compressed medium from escaping from the compression chamber. Since none of the three aforementioned seals are completely (gas) tight forever, it is not possible to prevent escape and thus the loss of compressed medium.

If a sealing system like the one depicted in FIG. 1 is used in a hydrogen compressor for example, until now explosion-proof and therefore more expensive operating materials and components had to be used since there is a risk of hydrogen escaping all around the compressor at all times.

The objective of the present invention is disclosing a sealing system of a generic type for two components that can be moved in relation to one another, in particular for a piston which can be moved in a cylinder chamber or for a piston rod, which excludes the aforementioned disadvantages and creates a secure and hermetic sealing possibility.

To attain this objective, a sealing system is provided that is characterized in that an ionic liquid is arranged between at least two of the moving seals.

In this case, the moving seals between which the ionic liquid is arranged are embodied in accordance with an advantageous embodiment of the inventive sealing system preferably as oil seals, gas seals or combinations of oil and gas seals.

If two or more moving seals are provided, an ionic liquid can be arranged a) exclusively between two adjacent seals, b) between all seals or c) between several adjacent seals with the prerequisite that there are four or more seals, whereby liquid-free intermediate sealing spaces remain, however.

Ionic liquids are low-melting organic salts with melting points between 100 and −90° C., whereby most of the known ionic liquids are also present in a liquid form at room temperature. In contrast to conventional molecular liquids, ionic liquids are entirely ionic and therefore exhibit new and unusual properties. Ionic liquids can be adapted comparatively easily in terms of their properties to given technical problems due to the variation of the structure of the anion and/or cation as well as due to the variation of their combinations. For this reason, they are frequently also designated as so-called “designer solvents.” In the case of conventional molecular liquids, on the other hand, only one variation of the structure is possible.

In contrast to conventional molecular liquids, the advantage of ionic liquids is also that they do not have a measurable vapor pressure. This means that as long as they do not reach their decomposition temperature the smallest traces of them do not vaporize even in a high vacuum. This yields the properties of incombustibility and environmental friendliness since ionic liquids are not able to get into the atmosphere as a result.

As already mentioned, the melting points of known ionic liquids are by definition under 100° C. The so-called liquids range, i.e., the range between the melting point and thermal decomposition, is as a rule 400° C. or more.

In addition, ionic liquids have high thermal stability. Often their decomposition points lie above 400° C. The density and mixing behavior with other liquids can be influenced and/or adjusted in the case of ionic liquids by the selection of ions. In addition, another advantage of ionic liquids is that they are electrically conductive and therefore can prevent electrical discharges which represent a potential danger.

The advantage of ionic liquids is that it is possible to completely separate them from the compressed medium with comparatively low equipment expense.

Carry-over of the ionic liquid by the compressed medium is no longer possible anymore since ionic liquids, as mentioned in the foregoing, do not have any vapor pressure.

In addition, when using an ionic liquid as a sealing medium, it is assured that the to-be-compressed and/or the compressed medium does not dissolve into the ionic liquid.

The generic work machine is characterized in that it features a sealing system in accordance with the invention.

The inventive sealing system as well as additional embodiments of the sealing system are explained in greater detail in the following on the basis of the exemplary embodiment depicted in FIG. 2.

Just like FIG. 1, FIG. 2 also depicts a lateral schematic sectional representation through a piston rod passage Z like those that are required in hydrogen cryo-compressors for example. Again a sealing system comprised of three seals A, B and C is provided, whereby all known seal types in any combination can be used as seals A, B and C.

According to the invention, an ionic liquid F is arranged between seals B and C as an (additional) sealing medium.

An absolutely reliable and long-lasting sealing barrier is henceforth created by means of this ionic liquid, which is subject to no wear or almost no wear. Even if the moving seals B and C have already become so leaky that the gaseous media are able to pass, they are still sufficiently tight for the ionic liquid F.

The risk of gas escaping and/or the problems associated with this are essentially reduced by the sealing system in accordance with the invention.

While (just as with the embodiment depicted in FIG. 1) gaseous medium continues to be removed from the intermediate space between seals A and B via line 1 and supplied to the suction side of the compressor, the chimney system described in FIG. 1 can be dispensed with and therefore the line 2 connected to the intermediate space between the seals B and C.

As already mentioned, it suffices if the ionic fluid F is arranged between two so-called oil seals B and C. Oil seals require substantially less maintenance and are longer lasting than conventional seals such as those that are used for sealing a piston which can be moved in a cylinder chamber.

An additional advantage of using an ionic liquid as a sealing medium is that simple detection of a leak is made possible because ionic liquids are visible. Auxiliary means such as leak indicator sprays, gas detectors, etc., are no longer necessary as a result.

The invention thus creates a sealing system for two components that can be moved in relation to one another, in particular for a piston which can be moved in a cylinder chamber or for a piston rod, the sealing system having two or more moving seals, which compared with conventional sealing systems requires substantially less maintenance and is longer lasting.

It is advantageous that particularly even if the seals being used are already leaking gas, there is no escape of the ionic liquid to begin with. Even in cases when there is an escape of the ionic liquid, it is not critical since the inventive sealing system does not become untight until there is a complete loss of the ionic liquid.

It is emphasized once again that the inventive sealing system is not intended for use just in piston rod passages like those depicted in FIGS. 1 and 2, but basically whenever a sealing system must be created for two components that can be moved in relation to one another.

1-3. (canceled)

4. A sealing system for two components that are moveable in relation to one another, in particular for a piston which is moveable in a cylinder chamber or for a piston rod, the sealing system having two or more moving seals, wherein an ionic liquid is arranged between at least two of the moving seals.

5. The sealing system according to claim 4, wherein the moving seals are embodied as oil seals, gas seals or combinations of oil and gas seals.

6. A work machine of any type, in particular compressors, having at least one sealing system according to claim 4.

7. A work machine, comprising:
a first component;
a second component, wherein the second component is moveably disposed within the first component, and wherein a passage is defined between a wall of the first component and a wall of the second component; and
a sealing system disposed in the passage, wherein the sealing system includes a first seal, a second seal, and an ionic liquid disposed between the first seal and the second seal.

8. The work machine according to claim 7, wherein the first component is a cylinder chamber and wherein the second component is a piston.

9. The work machine according to claim 7, wherein the sealing system further includes a third seal.

10. The work machine according to claim 9, further comprising a gas removal line having a first end disposed between the second seal and the third seal.

11. The work machine according to claim 10, wherein a second end of the gas removal line is disposed within a suction side of a compressor.

12. The work machine according to claim 7, wherein the first seal and the second seal are oil seals.
